(19) United States
(12) Patent Application Publication
(10) Pub. No.: US 2012/0175824 A1
(43) Pub. Date: Jul. 12, 2012

(54) Method of and Apparatus for Making a Composite Material

(76) Inventor: Alexander Fergusson, London (GB)

(21) Appl. No.: 13/395,828

(22) PCT Filed: Sep. 14, 2010
(86) PCT No.: PCT/GB2010/051540

§ 371 Date: Mar. 13, 2012

(30) Foreign Application Priority Data
Mar. 17, 2011 (GB) 0916019.3

(51) Int. Cl. B29C 70/44; B29C 43/12

(52) U.S. Cl. 264/571; 425/388

(57) ABSTRACT

The invention discloses a method of making a composite material comprising the steps of: positioning dry fabric reinforcement around at least part of a tool; hermetically sealing a vacuum bag around the dry fabric reinforcement and the tool; creating pressure differential between the inside of the vacuum bag and the outside of the vacuum bag such that the pressure within the vacuum bag is less than the pressure outside the vacuum bag; introducing resin into the dry fabric reinforcement; and curing the resin. The invention further discloses apparatus for making a composite material in accordance with the method.

### FIELD OF THE INVENTION

This invention relates to a method of, and apparatus for, manufacturing composite materials.

### BACKGROUND TO THE INVENTION

Existing methods of creating composite materials often require the use of a rigid mould in which the materials are laid before being sealed and shaped according to the mould. Methods for making such composite materials include resin transfer moulding, and resin infusion under flexible tooling (RIFT). Such a system is shown in FIG. 1. RIFT uses a rigid lower mould 10, for example an aluminium base plate, being either flat or shaped to a desired configuration, and a flexible upper membrane, or vacuum bag 20. The mould surface is coated with an appropriate release material 12, and dry fabric reinforcement 14 is laid onto the mould 10. Dry fabric reinforcement is fabric that does not contain any resin. A layer of peel ply 16 is placed on top of the reinforcement fabric and an induction medium 18 placed on top of the peel ply. Peel ply is a tightly woven fabric, often nylon, and impregnated with some type of release agent. The layers are then covered with a vacuum bag 20, which is sealed to the base plate using tape 22. A resin inlet 24 and air outlet 26 are sealed within the vacuum bag.

A vacuum pump is connected to the air outlet 26 and switched on until a vacuum of approximately −1 bar is created within the vacuum bag before the vacuum pump is turned off and the air outlet 26 sealed. Resin is then allowed to flow into the system through the resin inlet due to the pressure differential. Because of the vacuum within the bag, the resin is drawn along the induction medium until the whole ‘lay-up’ is completely wet.

The inlet and vacuum port are then sealed and the resin cured under the appropriate conditions. The vacuum port may be left open if desired.

A problem with existing methods is that the rigid bottom plate must be cast or machined to a particular shape in order for a composite product to be made to that shape. Such moulds are costly to produce, making ‘one-off’ shapes expensive. Further, the mould plate is only capable of determining the profile of one surface of the component. Composite products with varying 3-dimensional surfaces cannot be made using the same apparatus. If it is desired to produce curvature on both surfaces of the component then an additional mould must be used to determine the shape of the opposing surface. Such components with curvature on both surfaces, for example an aerofoil profile such as that on a wind turbine or propeller blade, require the use of additional tool, either creating a matched mould process, for example, resin transfer moulding (RTM) or requiring the end component to be made of more than one component on more than one tool with the components subsequently being bonded/attached to each other to create the end component.

Furthermore, current processes that wet-out dry fabrics in conjunction with a vacuum bag and only one rigid tool, for example, RIFT and resin film infusion (RFI) are only capable of determining the shape of one curved surface at a time. If a component with more than one curved surface is required, for example a rotor blade which has two non-complementary curved surfaces, then the component cannot be moulded in a single step unless the fibres are already impregnated, or wetted-out, with resin before going into the vacuum bag, or more than one rigid tool is used. “non-complementary” is used to mean that the shape of a first surface does not conform to the shape of a second surface.

A further method of making a composite material is to put a tool (or former), with ‘pre-preg’ material laid up onto the tool, into a vacuum bag, remove air from within the vacuum bag and apply heat, or place the bag into an auto-clave if additional pressure is required. Prepregs are sheets of a stiffening fibre/fabric (e.g. carbon fibre) that are pre-impregnated with resin before they are laid up on the tool/mould. Although prepreg fabrics already contain resin, heat and/or pressure is required to fully wet-out and consolidate the fabric while the resin cures. The autoclave exerts a high pressure on the vacuum bag and results in the layers of material being forced together. To make thicker composites, more layers of pre-preg fibre are placed within the vacuum bag. Due to the high temperatures and pressures required in autoclaves, the cost of producing composite materials using this method is relatively high.

Existing methods for producing fibre reinforced plastic components may utilise fluid force to wet out the composite material, however, these require the use of at least one rigid external tool. Generally, it is necessary to use mechanical force to wet-out a composite material and apply it to a mould if the use of a rigid external mould is to be avoided. Mechanical force means that the resin is applied to the reinforcement by way of temporary localised direct pressure using, for example, rollers.

Where a vacuum bag is to be used to improve the quality of a component that has been wet-out using mechanical methods, the component must be wet-out and applied to the tool prior to being positioned in a vacuum bag with the required ancillary materials. This process is time consuming.

The present invention takes these methods as a starting point.

### SUMMARY OF THE INVENTION

Accordingly, the present invention is directed to a method of making a composite material comprising the steps of:
positioning composite reinforcement around at least part of a tool;
hermetically sealing a vacuum bag around the composite reinforcement and the tool;
creating pressure differential between the inside of the vacuum bag and the outside of the vacuum bag such that the pressure within the vacuum bag is less than the pressure outside the vacuum bag;
wetting-out the composite reinforcement; and
curing the resin,

wherein the tool is at least partially internal to the cured structure.

Such a method, using a rigid tool that is at least partially, if not wholly, internal to the cured and finished composite structure, or product, and a flexible vacuum bag can be used to determine the profile of the composite component on all surfaces with a single tool whilst existing techniques can only determine the profile of the composite component on one surface with a single tool. In order to determine the profile on more than one surface it is currently necessary to use either a at least two rigid tools, or use fibres that are mechanically wet-out with resin before being placed on the mould or vacuum bag. Because only a single internal tool is required there is no need for expensive matched tooling and more than one tool because the surfaces are moulded by a single tool, and the rigid tool can be manufactured to the desired geometry. Multiple internal tools could be used if required. As a result of the relatively low pressures involved, the tool need only be able to support its own weight and that of the material used in making the component and withstand atmospheric pressure. The rigid tool used in this method and apparatus allows all of the surfaces of the composite product to be formed simultaneously. The use of rigid external tools is not necessary according to the present invention. The application of a vacuum before and during wet-out of the composite can also significantly reduce the formation of dry spots, resin pockets, trapped air and other defects. The vacuum bag provides a uniform pressure to the reinforcement and the tool. Where extra pressure is required, the method may be performed within an autoclave, or using hydraulic pressure, for example, fluid force by submerging the vacuum bag in liquid. When in the liquid, heat may also be applied by heating the liquid to the required temperature. This allows for relatively quick heating and cooling of the arrangement.

In one preferred embodiment, the composite reinforcement is prepreg composite. Prepreg composite can comprises controlled proportions of resin to allow for a consistent and high quality product. Prepreg is typically refrigerated until the day before use to prevent the resin curing. The partially cured resin is highly viscous and requires the use of pressure and temperature for the resin to flow and fully wet out the composite reinforcement. The use of prepreg composite allows for pre-impregnated reinforcement to be used, thereby not requiring the resin to be introduced into the sealed vacuum bag during an additional step. This may reduce the time required to manufacture the composite structure.

In an alternative embodiment, the composite reinforcement is dry composite reinforcement and resin is introduced into the dry fabric reinforcement prior to curing and after the step of hermetically sealing the vacuum bag.

In one embodiment, the resin is introduced by creating a vacuum within the vacuum bag and allowing liquid resin to ingress through an inlet in the vacuum bag due to the pressure differential between inside and outside the vacuum bag.

Preferably, the method further comprises the step of providing an induction medium to assist the ingress of liquid resin. The induction medium is a relatively low resistance pathway which is used to channel the resin longitudinally along the length of the vacuum bag. From the induction medium the resin is able to pass through the permeable peel ply, if present, and into the dry fibre reinforcement.

Advantageously, the induction medium comprises any one of: recesses on the surface of the tool; a sheet of plastics mesh; or lengths of plastics material. Scoring the tool itself will result in a finished composite material with resin filled channels where the scoring was present, which may be desirable.

In an alternative embodiment, the resin is introduced by way of sheets of resin positioned on the dry fabric reinforcement, prior to hermetically sealing the vacuum bag. This negates the need to have a resin inlet in the vacuum bag. Resin sheets comprise viscous resin held between non-stick material and kept cool, either refrigerated or frozen, to prevent the resin from seeping out and to stop it from curing until the material is placed in the mould.

Preferably, a vacuum pump creates a pressure differential within the vacuum bag, causing the resin sheets to be forced into the dry fabric reinforcement due to the pressure exerted on them. Temperature and/or pressure may be used to allow the sheets to flow more easily and to force the resin into the dry fabric reinforcement. The resin sheets may be used in combination with prepreg composite reinforcement. For example, it may be advantageous to place resin film between prepreg and a tool comprised of a cellular material, such as wood, to improve adhesion between the core and fibre reinforced plastic.

It is advantageous if the atmospheric pressure outside the vacuum bag is substantially one atmosphere. A further advantage of the present invention is that because the pressure differential does not need to be large as that produced in an autoclave and therefore, honeycomb tools, foam, or partially foam, tools, or cores, can be used which would otherwise be deformed or destroyed within an autoclave. This allows the tool to be lightweight and the production costs of the composite component to be kept relatively low compared to using an autoclave, which may produce pressures of up to 13 789 515 Pa (2000 psi) and temperatures of up to 815° C. (1500° F.). The process of the present invention can be used at ‘normal’ atmospheric pressure (101325 Pa) and the resin cured at a temperature substantially less that that in an autoclave, for example 120° C., although the temperature is dependent upon the resin used. Such pressures are considerably lower than those within an autoclave.

It is preferable that the tool is a low melting point plastics material and subsequent to the curing of the resin, the plastics material is heated above the melting point and removed from the composite product to create a hollow composite structure. If a low-melting point plastics tool is used, once the composite product is manufactured around the tool, the finished product is then heated above the melting point of the plastics material, making the plastics material sufficiently flowable and/or liquid that it can be removed from the composite product via a hole in the composite material. Alternatively, the composite structure can be split open and the plastics material melted out of the composite. This allows hollow composite structures to be used for moulding further products within them. Other methods of removing the tool may be used, for example, other thermal methods, chemical methods or mechanical methods, or a combination thereof.

The invention also relates to apparatus for making a composite material comprising an impermeable hermetically sealable vacuum bag, having at least one port to allow fluid communication between the inside of the bag and the outside of the bag, a substantially rigid tool for positioning within the bag and means for creating a pressure differential between the inside and outside of the vacuum bag.

Advantageously, the means for creating a pressure differential within the vacuum bag comprise a vacuum pump to reduce the pressure within the vacuum bag. For the vacuum bag, silicon vacuum bags or other types of vacuum bags may be used, for example, plastics materials such as polyethylene or the like. The vacuum bag should be sufficiently flexible to be shaped around the tool, and layers between the tool and the vacuum bag, without impressing any particular shape on the fibre reinforcement. The bag is preferably capable of being hermetically sealed. The vacuum bag may be heat resistant to allow for heat-curing of the resin.

Preferably, a second port of the vacuum bag is a resin inlet.

Advantageously, the tool comprises polymer foam, polymer honeycomb, solid plastic, metal foam, metal honeycomb, graphite foam, reinforced plastic composite, metallic foam, ceramic foam, composite foam, composite honeycomb or natural material, such as wood. The tool may be constructed from multiple components to form one complete tool. For example, it may comprise aluminium regions to allow for hard points for screws or bolts to be fed into. Furthermore, if it is known that one region of the composite is likely to be subjected to higher loads than another region, it may be desirable to use a higher strength foam in that region compared to lower stress regions.

Preferably, the apparatus further comprises an induction medium for assisting the ingress of resin. This is especially preferable in the use of liquid resin, rather than resin film, to enable longitudinal flow of the resin within the vacuum bag.

By way of examples, the process may be used, for manufacturing turbine blades, in boat manufacture and for making sporting equipment such as surf boards or skiing apparatus. Additionally, a composite structure may be created from an existing item, for example, a surf board, and the composite material subsequently used as a mould for producing replicas of the original tool. The surf board may be removed from the composite structure by the use of release film positioned prior to sealing of the vacuum bag, or the composite structure may be cut into a plurality of pieces. The structure may be provided with flanges to facilitate subsequent moulding from it.

Another advantage of the present invention is that the apparatus are all relatively easy to transport. Therefore the apparatus can be transported to a desired location and the composite component manufactured ‘on-site’ opposed to a composite structure having to be transported once it's manufactured.

The invention includes within its scope a method of, and apparatus for, making a composite material substantially as described herein with reference to and as illustrated in any appropriate combination of the accompanying text and/or drawings.

### BRIEF DESCRIPTION OF THE DRAWINGS

An embodiment of the invention will now be described, by way of example only, and with reference to the accompanying drawings, in which:

FIG. 2 is a cross-sectional diagrammatic illustration of apparatus for making composite material according to a first embodiment of the present invention; and

FIG. 3 is a cross-sectional diagrammatic illustration of apparatus for making composite material according to a second embodiment of the present invention.

### DETAILED DESCRIPTION OF EXEMPLARY EMBODIMENTS

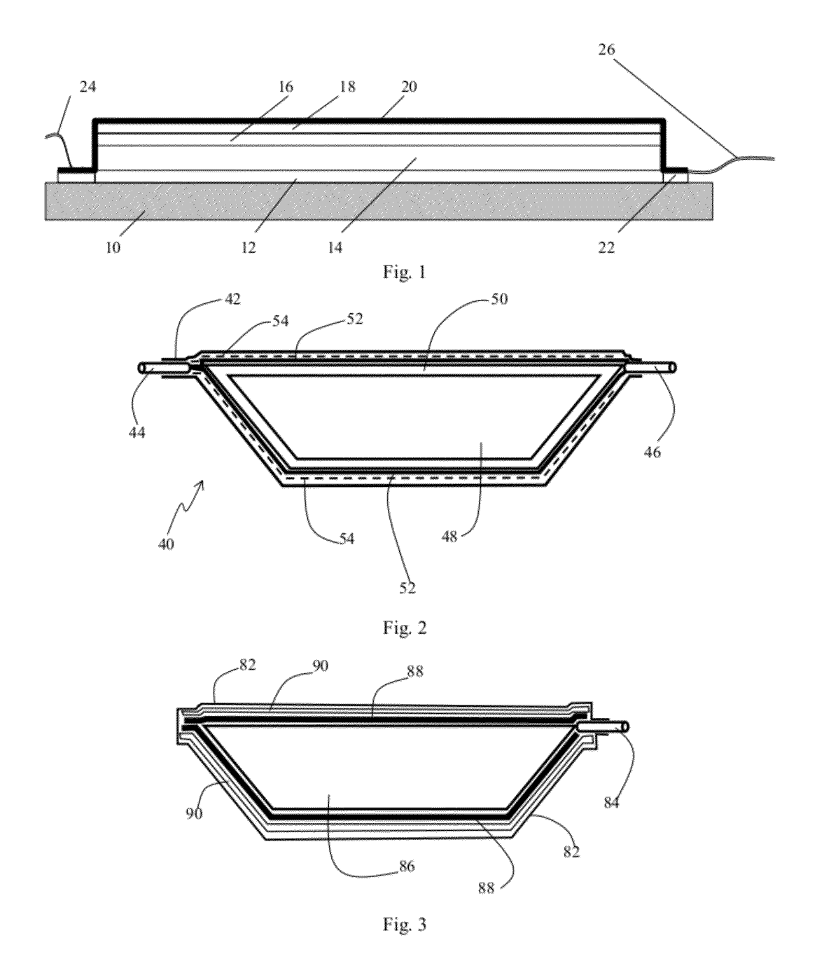

FIG. 2 shows apparatus 40 for making a composite material according to the present invention. The apparatus 40 comprises an impermeable vacuum bag 42 having a resin inlet 44 which is in fluid communication with an outlet 46. Within the vacuum bag is a tool 48, which is an integral rigid tool or core, having a 3-dimensional shape which provides strength and shape to the composite material during the manufacturing process. The tool 48 is wrapped in a layer of dry fibre reinforcement 50, such as carbon fibre or glass fibre. The dry fibre reinforcement 50 is coated with a peel ply 52, which is a permeable membrane to which resin does not stick, to allow the finished composite product to be removed from the vacuum bag. Surrounding the peel ply 52 is an induction medium 54, in the form of a highly permeable plastics mesh. The layers 50, 52, and 54 constitute a ‘lay-up’.

Once the tool 48 is in position with the dry fibre reinforcement 50, peel ply 52 and induction medium 54 surrounding it, the vacuum bag 42 is hermetically sealed using tacky tape (not shown). The resin inlet 44 is clamped closed and a vacuum pump (not shown) is connected to the outlet 46. The vacuum pump is operated to remove air from within the vacuum bag 42 and reduce the pressure within the vacuum bag 42 to create a pressure differential between the bag and the outside atmosphere, for example −1 bar. The vacuum bag 42 and the lay-up take the shape of the tool 48 therein due to the pressure differential. The resin inlet 44 is connected to a resin source and the inlet 44 is subsequently opened. The pressure differential between the inside of the vacuum bag 42 and the outside, drives the resin into the bag 42. The resin flows longitudinally along the induction mesh 54 and passes through the permeable peel ply 52 and into the dry fibre reinforcement 50. Once the dry fibre reinforcement 50 is sufficiently wetted with the resin the resin inlet 44 is closed. The vacuum pump can then be turned off in order to prevent wear on the parts of the pump. Alternatively, the pump may be left connected to the apparatus 40 so that excess resin or fumes may be drawn out of the vacuum bag 42. Once the lay-up is sufficiently wet, the resin is cured using known methods to harden it. Once the resin is cured, the hardened composite can be removed from the vacuum bag 42.

FIG. 3 shows a second embodiment of the present invention which is similar to that of the first embodiment without the resin inlet 44. The apparatus 80 comprises a vacuum bag 82 having an outlet 84 extending from the edge and allowing fluid communication from the inside of the bag 82 to the outside of the bag 82. A tool 86 is positioned within the vacuum bag 82 and a dry reinforcement fabric 88, for example carbon fibre, is positioned around the tool 86. Sheets of resin 90 are then wrapped around the dry reinforcement fabric 88.

When the resin 90 and the dry fabric reinforcement are in position, the vacuum bag 82 is hermetically sealed using tacky tape (not shown) and a vacuum pump (not shown) is attached to the outlet 84 and is used to remove air from the inside of vacuum, causing a pressure differential between the inside of the vacuum bag 82 and the outside of the vacuum bag 82. The pressure within the vacuum bag 82 is decreased so that the fabric moulds around the tool 86. The pressure exerted on the layer of resin, in conjunction with heat as required, is sufficient to force the resin sheet into the dry fabric 88. The resin is then cured according to known techniques.

Because the resin is in sheet form, there is no need to use an induction medium as with the first embodiment. A breather fabric may be substituted for the induction medium to better facilitate the evacuation of air and excess resin. A breather fabric is a highly porous fabric material that does not collapse under pressure thus aiding the egress of air and excess resin from the lay-up.

In order to make thicker materials the dry reinforcement fibre can be thicker rather than using multiple layers.

Numerous other variations and modifications to the illustrated construction may occur to the reader familiar with the art without taking the device outside the scope of the present invention. For example, applying peel ply or release fabric (not shown) to the tool and/or the outside of the resin sheets to ease removal of the finished product. Other methods of hermetically sealing the vacuum bag may also be used, such as heat sealing or other adhesives. Clearly other materials capable of being wrapped around the tool and other layers and of being hermetically sealed may also be used, for example, the vacuum bag may comprise a sheet of plastics film that is then sealed along at least three sides to form a bag.

The dry fabric reinforcement may be applied to the tool prior to the tool being put inside the bag or subsequent to the tool being put in the bag. Whilst the dry reinforcement fabric has been described as a layer, it may comprise multiple layers of the same, or different, material.

Whilst the invention has been described with reference to shaped and curved composite products, the invention is equally applicable to a sandwich panel, that is a flat sheet of composite material. Such sheets may have a core of foam or honey comb material or other types of cores, especially as previously describe herein, to make light weight sheet material.

“Resin” is intended to be generic term to describe the material that forms the matrix in a composite, for example epoxy resin used to form the matrix in which carbon fibres are the reinforcement. This ‘resin’, or matrix material, may be a thermoset plastic that is not fully cured, that is, it is still sufficiently liquid to flow through the fibre. Alternatively, as a reader skilled in the art will appreciate, thermoplastic materials may be used in the process disclosed herein, for example, by mixing two or more components that react to form a cured thermoplastic. Alternatively, solid thermoplastic material in the form of sheets, powder, fibres or fabric, may be arranged about the tool, and a combination of temperature and pressure used to melt the material to allow it to flow into the reinforcement material.

However, in especially preferred embodiments the resin is thermosetting plastic, such as epoxy resin or similar.

“Prepreg reinforcement” is intended to mean composite reinforcement comprising partially cured resin. The resin in a prepreg is partially cured such that the material can be handled without the difficulties associated with fabric that is wet-out with uncured resin, but it retains the ability to flow and wet-out the composite when sufficient pressure and heat are applied.

“Dry reinforcement fabric” is intended to mean a fabric or fibre that is not provided with resin prior to use.

“Composite reinforcement” is intended to include fabric reinforcement in addition to other reinforcement materials.

“Wetting out” is intended to mean the displacement of air form the reinforcement material by resin.

Two or more composite components may be made at the same time using the method described herein. Multiple tools, either of the same shape, or of different shapes, may be put in the same vacuum bag to create multiple components using dry reinforcement fabric as described herein.

1. A method of making a composite material comprising the steps of:
positioning composite reinforcement around at least part of a tool;
hermetically sealing a vacuum bag around the composite reinforcement and the tool;
creating pressure differential between the inside of the vacuum bag and the outside of the vacuum bag such that the pressure within the vacuum bag is less than the pressure outside the vacuum bag;
wetting-out the composite reinforcement; and
curing resin,
wherein the tool is at least partially internal to the cured composite structure.

2. A method according to claim 1, wherein the composite reinforcement is prepreg composite.

3. A method according to claim 1, wherein the composite reinforcement is dry composite reinforcement and resin is introduced into the dry fabric reinforcement prior to curing and after the step of hermetically sealing the vacuum bag.

4. A method according to claim 3, wherein the resin is introduced by allowing liquid resin to ingress through an inlet in the vacuum bag due to the pressure differential inside and outside the vacuum bag.

5. A method according to claim 4, wherein the method further comprises the step of providing an induction medium to assist the ingress of liquid resin.

6. A method according to claim 5, wherein the induction medium comprises anyone of: recesses on the surface of the tool; a sheet of plastics mesh; or lengths of plastics material.

7. A method according to claim 3, wherein the resin is introduced by way of sheets of resin positioned on the dry fabric reinforcement, prior to the hermetical sealing of the vacuum bag and wherein the pressure differential, causes the resin sheets to be forced into the dry fabric reinforcement due to the pressure exerted upon them.

8. A method according to claim 1, wherein the atmospheric pressure outside the vacuum bag is substantially one atmosphere.

9. A method of making a composite material according to claim 1, wherein the tool is a low melting point plastics material and subsequent to the curing of the resin, the plastics material is heated above the melting point and removed from the composite product to create a hollow composite structure.

10. Apparatus for making a composite material comprising an impermeable hermetically sealable vacuum bag, having at least one port to allow fluid communication between the inside of the bag and the outside of the bag, a substantially rigid tool for positioning within the bag and means for creating a pressure differential between the inside and outside of the bag, wherein the pressure inside the bag is less than the pressure outside the bag.

11. Apparatus according to claim 10, wherein the means for creating a pressure differential within the vacuum bag comprise a vacuum pump to reduce the pressure within the vacuum bag.

12. Apparatus according to claim 10, wherein a second port of the vacuum bag is a resin inlet.

13. Apparatus according to claim 10, wherein the tool comprises polymer foam, polymer honeycomb, solid plastic, metal foam, metal honeycomb, graphite foam, composite foam, composite honeycomb or natural material.

14. Apparatus according to claim 10, wherein the apparatus further comprises an induction medium for assisting the ingress of resin when the system is in use.

15. (canceled)

16. A method according to claim 3, wherein the atmospheric pressure outside the vacuum bag is substantially one atmosphere.

17. A method of making a composite material according to claim 3, wherein the tool is a low melting point plastics material and subsequent to the curing of the resin, the plastics material is heated above the melting point and removed from the composite product to create a hollow composite structure.

18. Apparatus according to claim 11, wherein a second port of the vacuum bag is a resin inlet.

19. Apparatus according to claim 11, wherein the tool comprises polymer foam, polymer honeycomb, solid plastic, metal foam, metal honeycomb, graphite foam, composite foam, composite honeycomb or natural material.

20. Apparatus according to claim 18, wherein the tool comprises polymer foam, polymer honeycomb, solid plastic, metal foam, metal honeycomb, graphite foam, composite foam, composite honeycomb or natural material.

21. Apparatus according to claim 11, wherein the apparatus further comprises an induction medium for assisting the ingress of resin when the system is in use.
